(19) United States
(12) Patent Application Publication
(10) Pub. No.: US 2023/0034940 A1
(43) Pub. Date: Feb. 2, 2023

(54) PRODUCTION METHOD OF TRANSPARENT POLYCRISTALLINE SILICON NITRIDE CERAMICS WITH SPARK PLASMA SINTERING TECHNIQUE

(71) Applicant: ESKISEHIR TEKNIK UNIVERSITESI, Eskisehir (TR)

(72) Inventors: Semra KURAMA, Eskisehir (TR); Levent KOROGLU, Eskisehir (TR); Gizem AK, Eskisehir (TR); Ozden KISACIK, Eskisehir (TR)

(73) Assignee: ESKISEHIR TEKNIK UNIVERSITESI, Eskisehir (TR)

(21) Appl. No.: 17/788,299

(22) PCT Filed: Nov. 12, 2020
(86) PCT No.: PCT/TR2020/051091

§ 371 Date: Jun. 23, 2022

(30) Foreign Application Priority Data
Dec. 27, 2019 (TR) 2019/21933

(51) Int. Cl. C04B 35/587; C04B 35/645; C04B 35/626

(52) U.S. Cl. CPC C04B 35/587; C04B 35/645; C04B 35/6261; C04B 35/6264; C04B 35/62655; C04B 2235/3873; C04B 2235/3225; C04B 2235/666; C04B 2235/6562; C04B 2235/6567; C04B 2235/6565; C04B 2235/606

(57) ABSTRACT

Invention relates to the production method of transparent polycrystalline silicon nitride ceramics which are obtained by sintering raw materials in powder form with powder metallurgy in the field of advanced technical ceramics and are used in the aviation and defense industry. More specifically, the present invention relates to a transparent polycrystalline silicon nitride ceramic material production method which allows obtaining transparent polycrystalline silicon nitride ceramic material at lower temperature and pressure values compared to the prior art in order to reduce production costs, facilitate the production process and reduce quantity/number of material and devices used, for this, unlike conventional sintering technique, spark plasma sintering technique in which heat is produced under high electrical current is used.

### TECHNICAL FIELD

Invention relates to the production method of transparent polycrystalline silicon nitride ceramics which are obtained by sintering raw materials in powder form with powder metallurgy in the field of advanced technical ceramics and are used in the aviation and defense industry.

More specifically, the present invention relates to a transparent polycrystalline silicon nitride ceramic material production method which allows obtaining transparent polycrystalline silicon nitride ceramic material at lower temperature and pressure values compared to the prior art in order to reduce production costs, facilitate the production process and reduce quantity/number of material and devices used, for this, unlike conventional sintering technique, spark plasma sintering technique in which heat is produced under high electrical current is used.

### PRIOR ART

Nowadays, scientists and engineers work together and are always in a race for improving materials and producing better materials for replacing them with old ones. Transparent ceramic materials that find application areas in the aviation and defense sector such as; lasers, transparent armors, night vision tools, high speed infrared guided missiles, optical amplifiers, electromagnetics (EM) and infrared (IR) windows, etc., are one of the materials that scientists and engineers have been working hard for many years and are still in focus of attention. Transparent ceramic material types are Alumina, Zirconia (ZrO₂), Boron Nitride (BN), Aluminum Nitride (AlN), Titanium Nitride (TiN), Silicon Oxynitride (Si₂N₂O), Silicon Carbide (SiC), Silicon Nitride (Si₃N₄). Of these, Silicon Nitride (Si₃N₄) have ideal material property composition. Silicon Nitrides (Si₃N₄) which are as light as Silicon Carbide (SiC) exhibit excellent thermal shock resistance thanks to their microstructures and impact and shock resistance thanks to their high hardness.

The production of single crystal transparent silicon nitride ceramics has many problems such as high cost, long production time, small-scale production, product shaping difficulty and high fragility. Compared to single crystal ceramics, polycrystalline transparent ceramics have many advantages such as low cost, shorter production time, large-scale production, product shaping ease and low fragility.

Although there are no commercially used polycrystalline silicon nitride ceramics, it is possible to obtain polycrystalline transparent silicon nitride ceramics in conventional methods only under high temperature (1800-1850° C.) and high pressure (50 MPa-15.6 GPa). The high temperature and especially high pressure values increase the production cost of materials, complicate the production process, increases the quantity/number of material and devices used. This situation has revealed the require for a method regarding obtaining polycrystalline silicon nitride ceramic material under lower temperature and pressure values.

In the thesis titled “Investigation of Effects of Starting Composition and Sintering Conditions on Transparent SiAION Ceramics” (Suna Avcioğlu, Supervisor: Semra Kurama, October 2013), the effects of sintering additives on the optical properties of SiAION were investigated. In the method specified in the thesis study; SiAION material was prepared as a solid phase solution by using Si₃N₄, AlN, Al₂O₃ and additives (La₂O₃, Y₂O₃ and Dy₂O₃) in different ratios and different m and n values. Although spark plasma sintering (SPS) technique has been used in the thesis mentioned, the sintering is carried out at 50 MPa pressure and with different durations. AlN, Al₂O₃ and additives in the material structure wet Si₃N₄ by forming a liquid phase, and at the end of the process, it forms a new product that contains different phase. This new product which is a derivative of Si₃N₄, contains many phases and has different mechanical, chemical and thermal properties than Si₃N₄ used as initial raw material. Studies on the transparency feature of SiAlON which is widely known and derivative of Si₃N₄, increase. Since SiAlON material is a solid solution and does not have a single fixed point composition, it is possible to diversify the SiAlON ceramics by preparing them with the composition Si₁₂₋₍ₘ₊ₙ₎Alₘ₊ₙOₙN₁₆₋ₙ and by changing the m and n values. In short, it is completely different from Si₃N₄ that is a single phase product in terms of composition design, final product phases and product properties.

The article titled “Optimization of the Optical Properties of α-SiAlON through a Decrease in Starting Powder Size” (S. Kurama, S. Avcioğlu, E. Ayas; May 2015), was intended for the production of SiAlON material; and here Si₃N₄, AlN, Al₂O₃ and additives were used to prepare the solid solution. With this aspect, the article study shows a significant difference from single phase Si₃N₄ ceramics that do not contain AlN ve Al₂O₃ sources. In addition, the article focuses on decreasing sintering temperature by reducing the initial powder size of the mixture of 4 raw materials. The positive effect of reducing the initial powder size on the decrease of the sintering temperature is widely explained in the literature with studies. However, in our present patent application, this product is developed by only controlling the sintering pressure and amount of grain boundary phase with additive. Besides in the present invention, the initial material does not transformed, it is preserved as Si₃N₄. In short, the method stated in this article is completely different from the method of the present invention. In the article, it is not mentioned about obtaining permeability by sintering the initial raw material directly in the form of Si₃N₄ by controlling grain size and secondary phase by changing liquid phase amount and pressure.

In our present patent application titled “Production Method of Transparent Polycrystalline Silicon Nitride Ceramics with Spark Plasma Sintering Technique”, instead of SiAlON which is a solid solution produced from Si₃N₄, a method for increasing the transparency of Si₃N₄ directly by liquid phase sintering of it by using SPS (Spark Plasma Sintering) technique is presented. Here, unlike the prior art, there is a study about gaining transparency by just sintering Si₃N₄ without using extra initial raw materials (such as AlN, Al₂O₃) and without creating any new phase.

In the patent document no. CN108455990A, α-Si₃N₄ is an initial raw material and this phase does not exist in the final product. Namely, Si₃N₄ is the initial raw material that is just used to obtain a new product and phase. Si₃N₄ powder is also used as an initial raw material in advanced technical ceramics, and each initial composition design and sintering parameters make it possible to obtain a product with different properties. Here, even if same sintering techniques (SPS, HIP, HP and GPS) are used, product diversity and different features can be developed. In the process mentioned in the patent no. CN108455990A, it is not mentioned about obtaining permeability by sintering the initial raw material directly in the form of Si₃N₄ by controlling grain size and secondary phase by changing liquid phase amount and pressure.

In the patent document no. CN101255058A, similar to the previous CN patent document, Si₃N₄ is used as a raw material and a structural nitride ceramic with improved mechanical properties is obtained as a result of sintering with SPS. However, here, it is not mentioned about developing products for application of optical properties functionally in addition to the application areas based on commonly used structural properties of Si₃N₄.

As a result, the require for obtaining transparent polycrystalline silicon nitride ceramic material at lower temperature and pressure values compared to the prior art in order to reduce production costs, facilitate the production process and reduce quantity/number of material and devices used, has caused the present innovative solution to emerge out.

### OBJECTIVES AND SHORT DESCRIPTION OF THE INVENTION

The aim of the invention is to present the production method of transparent polycrystalline silicon nitride ceramics which are obtained by sintering raw materials in powder form with powder metallurgy in the field of advanced technical ceramics and are used in the aviation and defense industry.

More specifically, aim of the invention is to present a transparent polycrystalline silicon nitride ceramic material production method which allows obtaining transparent polycrystalline silicon nitride ceramic material at lower temperature and pressure values compared to the prior art in order to reduce production costs, facilitate the production process and reduce quantity/number of material and devices used, for this, unlike conventional sintering technique, spark plasma sintering technique in which heat is produced under high electrical current is used.

Another aim of the invention is to reduce production costs of transparent polycrystalline silicon nitride ceramic material, facilitate the production process of it and reduce quantity/number of material and devices used during production of it.
Invention is a production method for transparent polycrystalline silicon nitride ceramic material and comprises following steps:
obtaining the initial powder mixture by adding only one of powders Y₂O₃, Dy₂O₃ and Eu₂O₃ each time (composition) with different proportions (ratios) between 0-10% to the silicon nitride (Si₃N₄) powder, ensuring a homogeneous mixture of them,

by using spark plasma sintering technique applying pressure of 15-50 MPa is applied during sintering process;
firstly; reaching sintering temperatures of 1700-1800° C. with heating rates of 50-100° C./min,
keeping the temperature constant at the sintering temperatures of 1700-1800° C. for 5-20 minutes,
then reducing the temperature to the room temperature with cooling rates of 350-600° C./min.

In order to ensure homogeneous mixture of initial powder mixture; present invention comprises following steps:
mixing the initial powder mixture in alcohol environment for 3-5 hours by using an axial ball mill,
then removing the alcohol by means of rotating evaporator.

### DETAILED DESCRIPTION OF THE INVENTION

The invention presents a transparent polycrystalline silicon nitride ceramic material production method which allows obtaining transparent polycrystalline silicon nitride ceramic material at lower temperature and pressure values compared to the prior art, for this, unlike conventional sintering technique, spark plasma sintering technique in which heat is produced under high electrical current is used. Thus, reducing production costs of transparent polycrystalline silicon nitride ceramic material, facilitating the production process of it and reducing quantity/number of material and devices used during production of it are aimed.

First of all, obtaining polycrystalline silicon nitride ceramic with spark plasma sintering technique applied in the present innovative method brings important advantages. Unlike conventional sintering techniques, spark plasma sintering technique produces heat under high electric current. In this technique, by applying high-density electric current under the applied mechanical pressure, arc is created on the powders and sintering is carried out with the effect of the pressure and temperature occurred. In this way, it is possible to produce polycrystalline transparent silicon nitride ceramic materials which have high purity, high density and high mechanical properties in shorter times. In addition, thanks to method applied here, the production of polycrystalline silicon nitride ceramic materials at lower temperatures (1700-1800° C.) and lower pressure (15 MPa-50 MPa) compared to conventional production methods reduces the product cost and makes easier the production process.

In the present innovative production method of the polycrystalline transparent silicon nitride ceramic material, α-Si₃N₄, Y₂O₃, Dy₂O₃ and Eu₂O₃ powders are used separately in each composition as initial material. Firstly, only one of the powders Y₂O₃, Dy₂O₃ and Eu₂O₃ is added with different proportions of 0-10% to the silicon nitride (Si₃N₄) powder. In order to obtain homogeneous mixture, the initial powder mixture is mixed in alcohol environment for 3-5 hours by using an axial ball mill. Subsequently, homogeneous initial powder mixture is obtained by removing the alcohol with the rotating evaporator. Sintering process with spark plasma sintering technique is started by using the homogeneous initial powder mixture obtained.

In the sintering process carried by using spark plasma sintering technique; first of all, sintering temperatures of 1700-1800° C. are reached with heating rates of 50-100° C./min. The temperature is kept constant at the sintering temperatures of 1700-1800° C. for 5-20 minutes. Then, the temperature is reduced to the room temperature with cooling rates of 350-600° C./min. A pressure of 15-50 MPa is applied during the sintering process. With the characterization tests applied at the end of the process, it has been proven that the Si₃N₄ ceramics sintered has a polycrystalline structure and transparent optical feature.

Unlike the conventional methods, with the present innovative method; permeability is obtained by directly sintering the initial raw material in the form of Si₃N₄ by controlling grain size and secondary phase by changing liquid phase amount and pressure. In addition, unlike other methods, there is no new product and phase transformation in the system as well as there is no change or effect related to the initial powder size.

Applying different sintering pressures and adding the amount of additives in the present innovative method makes the method of the invention different from the sintering conditions used in SiAlON ceramics. Using SPS (Spark Plasma Sintering) as sintering technique in this system is not monotony, there are no techniques other than SPS, GPS (Gas Pressure Sintering), HIP (Hot Isostatic Pressure) and HP (High-pressure) due to the high pressure requirement for the production in this area. The important difference achieved by the present innovative method is the optimization of sintering parameters and minimum phase formation, and all of them have been achieved in Si₃N₄ ceramic. Also here, in addition to the application areas based on the commonly used structural properties of Si₃N₄, product development for application of optical properties functionally has been provided. Besides, in the present innovative method, this product has been developed by only controlling the sintering pressure and, grain boundary phase amount via additive material. Moreover, the initial material was absolutely not transformed, it was preserved as Si₃N₄.

Shortly, in our present patent application titled “Production Method of Transparent Polycrystalline Silicon Nitride Ceramics with Spark Plasma Sintering Technique”, instead of SiAlON which is a solid solution produced from Si₃N₄, a method for increasing the transparency of Si₃N₄ directly by liquid phase sintering of it by using SPS (Spark Plasma Sintering) technique is presented. Here, unlike the prior art, there is a study about gaining transparency by just sintering Si₃N₄ without using extra initial raw materials (such as AlN, Al₂O₃) and without creating any new phase.

What is claimed is:

1. A production method for transparent polycrystalline silicon nitride ceramic material and characterized by; comprising following steps:
obtaining the initial powder mixture by adding only one of powders Y2O3, Dy2O3 and Eu2O3 each time (composition) with different proportions between 0-10% to the silicon nitride (Si3N4) powder, ensuring a homogeneous mixture of them,
carrying out sintering process by using spark plasma sintering technique.

2. A production method according to claim 1 for transparent polycrystalline silicon nitride ceramic material and characterized by; comprising following steps while a pressure of 15-50 MPa is applied during sintering process:
firstly; reaching sintering temperatures of 1700-1800° C. with heating rates of 50-100° C./min,
keeping the temperature constant at the sintering temperatures of 1700-1800° C. for 5-20 minutes,
then reducing the temperature to the room temperature with cooling rates of 350-600° C./min.

3. A production method according to claim 1 for transparent polycrystalline silicon nitride ceramic material and characterized by; in order to ensure homogeneous mixture of initial powder mixture; comprising following steps:
mixing the initial powder mixture in alcohol environment for 3-5 hours by using an axial ball mill,
then removing the alcohol by means of rotating evaporator.
